(19) United States
(12) Patent Application Publication
(10) Pub. No.: US 2026/0057865 A1
(43) Pub. Date: Feb. 26, 2026

(54) PICKUP DEVICE AND ELECTRIC STRING INSTRUMENT

(71) Applicant: YAMAHA CORPORATION, Hamamatsu-shi (JP)

(72) Inventors: Shinya MIZOSHIRI, Hamamatsu-shi (JP); Takuto YUDASAKA, Montreal (CA); Taku NAGAI, Hamamatsu-shi (JP)

(21) Appl. No.: 19/302,543

(22) Filed: Aug. 18, 2025

(30) Foreign Application Priority Data
Aug. 21, 2024 (JP) 2024-139689

(51) Int. Cl. G10H 3/18

(52) U.S. Cl. CPC G10H 3/186; G10H 3/181; G10H 2220/515

(57) ABSTRACT

A pickup device detects a vibration of a string of an electric string instrument. The pickup device includes a first coil wound in a first direction around a magnetic core that is configured to be disposed adjacent to the string. The pickup device further includes a second coil connected in series with the first coil, and wound in a second direction, which is different from the first direction. The pickup device further includes a third coil connected in series with the second coil, and wound in the second direction. The pickup device further includes a tuning circuit configured to adjust a magnitude of an induced electromotive force of the second coil. The first coil is configured to output a first signal representing the string vibration and any external magnetic field noise picked up by the first coil.

### CROSS-REFERENCE TO RELATED APPLICATIONS

The present application claims priority to Japanese Patent Application No. 2024-139689, filed Aug. 21, 2024. The contents of the application is incorporated herein by reference.

### BACKGROUND OF THE INVENTION

### Field of the Invention

The present disclosure relates to a pickup device and an electric string instrument.

### Description of the Related Art

One of the components that constitute an electric guitar is a pickup. Examples of pickups that convert a string vibration into an electrical signal include single pickups having a single coil, and humbucker pickups having two coils. In a case where a single pickup is used in an electric guitar, the tone of the output sound contains a hum noise caused by a change in an external magnetic field. A humbucker pickup can remove an external magnetic field noise from the tone of an output sound. A humbucker pickup includes a coil (referred to as coil A below) that converts a string vibration into an electrical signal, and an additional coil (referred to as coil B below) that is directly connected to coil A. The coil B has characteristics that are substantially equivalent to those of coil A, and is wound in the opposite direction to coil A. In a humbucker pickup, coil A and coil B detect a string vibration and an external magnetic field noise, and the outputs are added together. As a result, it is possible to output the tone of a string vibration while removing an external magnetic field noise.

In a humbucker pickup, as the inductance value of coil B increases, the peak frequency of the tone of the output sound decreases. For this reason, the tone of a humbucker pickup is sometimes described as a “rounder sound”, or “mellow”, when compared to the tone of a single pickup. On the other hand, there is also a need to remove a hum noise while maintaining the tone of a single coil pickup. To achieve this, for example, in a case where the sound quality of a humbucker pickup is to be brought closer to the sound quality of a single coil pickup, it is necessary to reduce the inductance value of coil B. However, in this case, because the characteristics of coil A and coil B will no longer be equivalent, it is difficult to remove an external magnetic field noise.

### SUMMARY OF THE INVENTION

The pickup device described in U.S. Pat. No. 7,259,318 B2 (hereinafter Patent Document 1) includes coil A, which is used in a single coil pickup, and another large coil (referred to as coil C below), which is connected to coil A via a tuning circuit. A string vibration is detected only by coil A, and a change in an external magnetic field is detected by coil A and coil C. In the pickup described in Patent Document 1, in order to reduce the inductance value of coil C (to suppress an effect on the tone), which is a different coil from coil A (the coil that detects a string vibration), the number of windings of coil C is reduced. Generally, when the number of windings of a coil is reduced, the induced electromotive force generated in the coil becomes smaller. However, in Patent Document 1, by increasing the cross-sectional area of coil C, a sufficient induced electromotive force is ensured for removing an external magnetic field noise. Furthermore, the tuning circuit adjusts the amplitude of the induced electromotive force of coil C (the amplitude of the external magnetic field noise), which improves the removal performance of the external magnetic field noise. As a result, it is possible to remove a hum noise while maintaining the tone of a single coil pickup (strictly speaking, the high frequency characteristics are attenuated due to the effect of coil C).

On the other hand, if the cross-sectional area of the coil C becomes large, for example, when mounting takes place on an electric string instrument such as an electric guitar, it is necessary to increase the cross-sectional area of a groove formed in the body of the electric guitar to accommodate the coil. From the standpoint of both sound quality and design, it is desirable to avoid forming grooves having a large cross-sectional area in the body of an electric guitar. Consequently, a reduction in size of the coils used in a pickup is required.

When attempting to reduce the cross-sectional area of coil C, it is necessary to adopt measures such as increasing the number of windings of coil C in order to ensure the induced electromotive force. However, in this case, because the inductance value of coil C becomes larger as described above, the sound quality deteriorates when compared to a single coil pickup having a single coil (for example, the tone changes from that of a single coil pickup, or the frequency characteristics are attenuated, particularly in the high range). In this way, in a case where a reduction in a hum noise is maintained, reducing the size of a coil and suppressing a decrease in sound quality are requirements that conflict with each other.

In view of the circumstances described above, one aspect of the present disclosure is a pickup device that is capable of achieving a reduction in the size of a coil, and suppressing a decrease in sound quality, while maintaining a reduction in a hum noise.

A pickup device according to an example aspect of the present disclosure is a pickup device for detecting a vibration of a string of an electric string instrument, including: a first coil wound in a first direction around a magnetic core that is configured to be disposed adjacent to the string; a second coil connected in series with the first coil, and wound in a second direction, which is different from the first direction; and a third coil connected in series with the second coil, and wound in the second direction; and a tuning circuit configured to adjust a magnitude of an induced electromotive force of the second coil, wherein the first coil is configured to output a first signal representing the string vibration and any external magnetic field noise picked up by the first coil, and wherein the second coil and the third coil are configured to output a second signal representing any external magnetic field noise picked up by the second and third coils.

An electric string instrument according to an example aspect of the present disclosure is an electric string instrument including: a string; a pickup device configured to detect a vibration of the string and including: a first coil wound in a first direction around a magnetic core that is configured to be disposed adjacent to the string; a second coil connected in series with the first coil, and wound in a second direction, which is different from the first direction; a third coil connected in series with the second coil, and wound in the second direction; and a tuning circuit configured to adjust a magnitude of an induced electromotive force of the second coil, wherein the first coil is configured to output a first signal representing the string vibration and any external magnetic field noise picked up by the first coil, and wherein the second coil and the third coil are configured to output a second signal representing any external magnetic field noise picked up by the second and third coils.

A pickup device according to another example aspect of the present disclosure is a pickup device for detecting a vibration of a string of an electric string instrument, the pickup device including: a first coil wound in a first direction around a magnetic core that is configured to be adjacent to the string; a second coil connected in series with the first coil, and wound around a first air core in a second direction, which is different from the first direction; and a third coil connected in series with the second coil, and wound around a second air core in the second direction, wherein the first coil is configured to output a first signal representing the string vibration and any external magnetic field noise picked up by the first coil, and wherein the second and third coils are configured to output a second signal representing any external magnetic field noise picked up by the second and third coils.

### BRIEF DESCRIPTION OF THE DRAWINGS

FIG. 1 is a schematic plan view for describing the configuration of a pickup device according to a first embodiment.

FIG. 2 is a diagram showing an equivalent circuit of the pickup device according to the first embodiment.

FIG. 3 is a diagram showing an equivalent circuit of a pickup device according to a second embodiment.

FIG. 4 is an equivalent circuit showing a pickup device according to another embodiment.

FIG. 5 is a perspective view showing a second coil and a third coil according to another embodiment.

### DESCRIPTION OF THE EMBODIMENTS

Hereinafter, a pickup device and an electric string instrument according to embodiments of the present disclosure will be described in detail with reference to the drawings.

### (1) First Embodiment

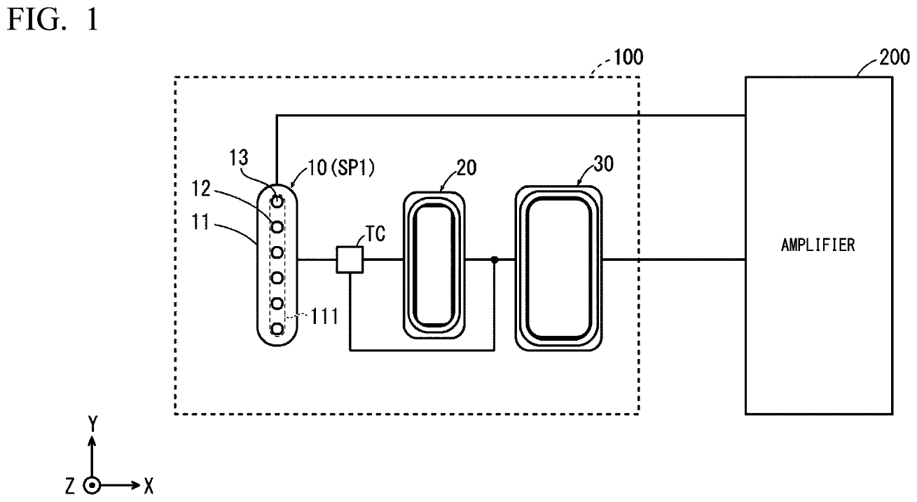

FIG. 1 is a schematic plan view for describing the configuration of a pickup device according to a first embodiment. In FIG. 1, arrows are provided indicating the mutually orthogonal X direction, Y direction, and Z direction in order to make the positional relationships clear. The X direction and Y direction are perpendicular to each other in a horizontal plane, and the Z direction corresponds to the vertical direction. The pickup device 100 includes a first coil 10, which is a single coil pickup SP1, a second coil 20, a third coil 30, and a tuning circuit TC. The pickup device 100 is incorporated into a string instrument. In the present embodiment, the pickup device 100 is incorporated into an electric guitar, and converts the vibration of a string into an electrical signal.

The first coil 10 has a bobbin 11. A coil wire 111 is wound around the bobbin 11 in a first direction. The bobbin 11 has six holes 12 formed at equal intervals, which correspond to the strings of the electric guitar. Each of the holes 12 extend in the Z direction. A pole piece 13 is inserted into each hole 12. The pole pieces 13 are cylindrical members made of steel. Each pole piece 13 is self-magnetized, or becomes magnetic as a result of making contact with a magnet (not shown). The first coil 10 is configured by the bobbin 11, the pole pieces 13, and the coil wire 111. The value of the number of windings of the first coil 10 is selected as appropriate from 5,000 to 10,000. For example, the number of windings of the first coil 10 is 7,000.

The second coil 20 and the third coil 30 are connected to the first coil 10 via the tuning circuit TC. The tuning circuit TC will be described later. The second coil 20 and the third coil 30 are each formed, for example, by winding a coil wire around an insulating structure (such as a bobbin). The number of windings of the third coil 30 is greater than the number of windings of the second coil 20. Furthermore, the number of windings of the first coil 10 is greater than the number of windings of the third coil 30. Although it depends on the cross-sectional area of the coil, in consideration of the mounting to the guitar, the value of the number of windings of the second coil 20 is selected as appropriate from 200 to 700. For example, the number of windings of the second coil 20 is 450. The value of the number of windings of the third coil 30 is selected as appropriate from 1,000 to 2,000. For example, the number of windings of the third coil 30 is 1,500. The coil wire of each of the second coil 20 and the third coil 30 is wound in a second direction, which is the opposite direction to the direction in which the coil wire 111 of the first coil 10 is wound around the bobbin 11 (first direction).

In the present embodiment, the vibration of the string is detected by the first coil 10, and a change in the external magnetic field is detected by the first coil 10, the second coil 20, and the third coil 30. The first coil 10 is capable of outputting a first signal, which includes the vibration of the string, and the external magnetic field noise. The second coil 20 and the third coil 30 are capable of outputting a second signal, which includes the external magnetic field noise. Because the second coil 20 and the third coil 30 have the coil wire wound in the opposite direction to the first coil 10, the phase of the external magnetic field noise in the first signal and the external magnetic field noise in the second signal is inverted by 180 degrees. Therefore, when the first signal and the second signal are added in a state where the amplitude of the external magnetic field noise in the second signal has been made equal to or approximately equal to the external magnetic field noise in the first signal, it is possible to cancel out the external magnetic field noise generated in the first coil 10. As a result, the hum noise can be reduced.

In the first embodiment, the second coil 20 and the third coil 30 each have an air core. The second coil 20 and the third coil 30 may each have a structure in which a core is inserted. The first coil 10 and the third coil 30 are connected to an amplifier 200. The amplifier 200 has a commonly used configuration, and the description will be omitted.

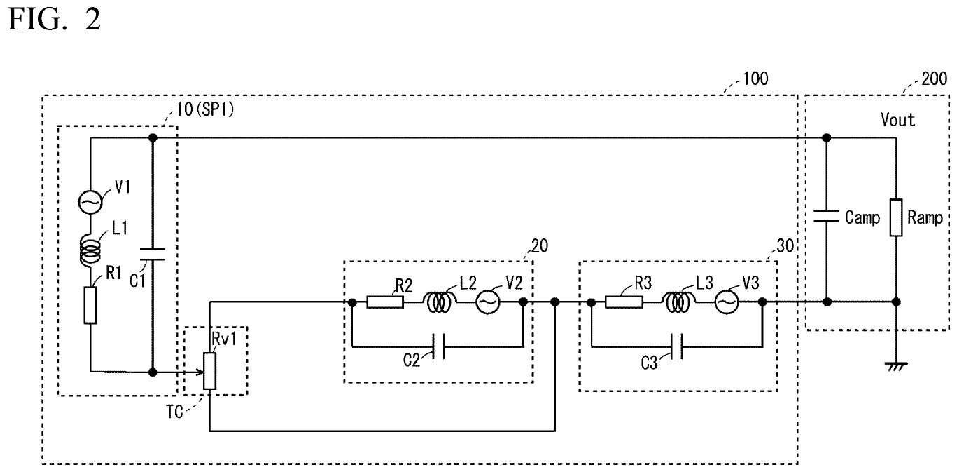

FIG. 2 is a diagram showing an equivalent circuit of the pickup device 100 according to the first embodiment. The equivalent circuit of the first coil 10 is represented by a power source V1 that provides an induced electromotive force v1, a resistor R1, a coil L1, and a capacitor C1. The equivalent circuit of the second coil 20 is represented by a power source V2 that provides an induced electromotive force v2, a resistor R2, a coil L2, and a capacitor C2.

The tuning circuit TC includes a variable resistor (volume) Rv1. The variable resistor Rv1 is, for example, a rotary volume. The variable resistor Rv1 of the tuning circuit TC is connected in series to the second coil 20, and adjusts the amplitude of the induced electromotive force v2 of the second coil 20.

The variable resistor Rv1, the coil L2, and the capacitor C2 form a low-pass filter with respect to the induced electromotive force v2 of the second coil 20. As a result, for example, in a case where the inductance value of the second coil 20 is high, the cutoff frequency becomes low. In this case, a reduction in the amplitude and a rotation in the phase occur. Therefore, it is not possible to cancel out the external magnetic field noise. As a result, the tone of the output sound includes the external magnetic field noise. In order to remove the external magnetic field noise, it is necessary to reduce the inductance value of the second coil 20, which is connected to the first coil 10 via the variable resistor Rv1.

Here, the inductance L of a coil will be described. The first to third coils 10 to 30 are coils referred to as solenoid coils. Given the length 1 of the coil in an axial direction, the cross-sectional area S of the coil, the number of windings N of the coil, and the (apparent) permeability u of the core, the inductance L of the coil is expressed by equation (1) below.

$$L = {K}_{n} \frac{μ S {N}^{2}}{l} \qquad ( 1 )$$

Kₙ is the Nagaoka coefficient. It can be determined that, in a case where an attempt is made to reduce the inductance L of a coil while taking into consideration the mounting of the pickup device 100 on a guitar, it is necessary to reduce the cross-sectional area S of the second coil 20.

Next, the induced electromotive force of a coil will be described. If the magnetic field is a constant sine wave irrespective of the position, given the amplitude a and the angular frequency ω, the magnetic flux density B(t) is expressed by equation (2) below.

$$B ( t ) = μαsin ( ω t ) \qquad ( 2 )$$

Given the cross-sectional area S of the coil, and the number of windings N of the coil, the induced electromotive force v(t) is expressed by equation (3) below according to Faraday's law of electromagnetic induction.

$$v ( t ) = - N \frac{d}{d t} \int {\int }_{s} B ( t ) ds = - NS μαωcos ( ω t ) \qquad ( 3 )$$

From the relationship in equation (3), in a case where the cross-sectional area S of the coil is made smaller (the size of the coil is reduced), it is possible to increase the number of windings of the coil in order to ensure the induced electromotive force v(t), or to insert a core into the coil in order to increase the permeability of the coil. However, if the number of windings of the coil is increased in order to ensure the induced electromotive force v(t), or a core is inserted into the coil in order to increase the permeability of the coil, from the relationship in equation (1), the inductance of the coil increases. Therefore, these measures are not realistic. Although it is possible to reduce the inductance value in a case where the cross-sectional area of the second coil is made smaller, the induced electromotive force for canceling out the component of the induced electromotive force v1 generated in the first coil 10 caused by a change in the external magnetic field can sometimes be insufficient.

Therefore, in the pickup device 100, the third coil 30, which is different from the second coil 20, is used. The equivalent circuit of the third coil 30 is represented by a power source V3 that provides an induced electromotive force v3, a resistor R3, a coil L3, and a capacitor C3. The third coil 30 is connected in series to the second coil 20. As a result, a shortfall in the induced electromotive force v2 of the second coil 20 can be compensated for by the induced electromotive force v3 of the third coil 30.

According to the pickup device 100 of the embodiment described above, the inductance value of the second coil 20 can be reduced while the cross-sectional area of the second coil 20 is made smaller. Furthermore, the cross-sectional area of the third coil 30 only needs to be large enough to compensate for the shortfall in the induced electromotive force v2 of the second coil 20. Consequently, it is possible to make the cross-sectional area of the third coil 30 smaller. As a result, it is possible to achieve a reduction in size of the coils inside the pickup device 100, and to suppress a decrease in sound quality, while maintaining a reduction in a hum noise.

Furthermore, because the second coil 20 has an air core, the permeability inside the second coil 20 becomes small. Therefore, the inductance value of the second coil 20 can be made even smaller.

### (2) Second Embodiment

Here, the resonance frequency of a coil will be described. Given the inductance L of the coil, and the capacitance value C of the coil, the resonance frequency f(0) is expressed by equation (4) below.

$$f ( 0 ) = \frac{1}{2 π} \sqrt{\frac{1}{L C} - \frac{{R}^{2}}{{L}^{2}}} \qquad ( 4 )$$

As mentioned above, the number of windings of the third coil 30 is greater than the number of windings of the second coil 20. Furthermore, according to equation (1) above, the inductance of a coil decreases when the number of windings of the coil is small. Therefore, the inductance value of the third coil 30 is greater than the inductance value of the second coil 20. Moreover, from equation (4), the resonance frequency value of the third coil 30 becomes smaller than the resonance frequency value of the second coil 20 (the resonance frequency value of the first coil 10 is smaller than the resonance frequency value of the second coil 20). From this relationship, there is a high possibility that the first coil 10 and the third coil 30 will cause a deterioration of the sound quality due to resonance and anti-resonance near the upper limit of the audible band. In addition, because the variable resistor Rv1 is connected to the second coil 20, the Q value of the second coil 20 becomes low. Therefore, the second coil 20 is unlikely to be involved in the deterioration of the sound quality due to resonance and anti-resonance near the upper limit of the audible band.

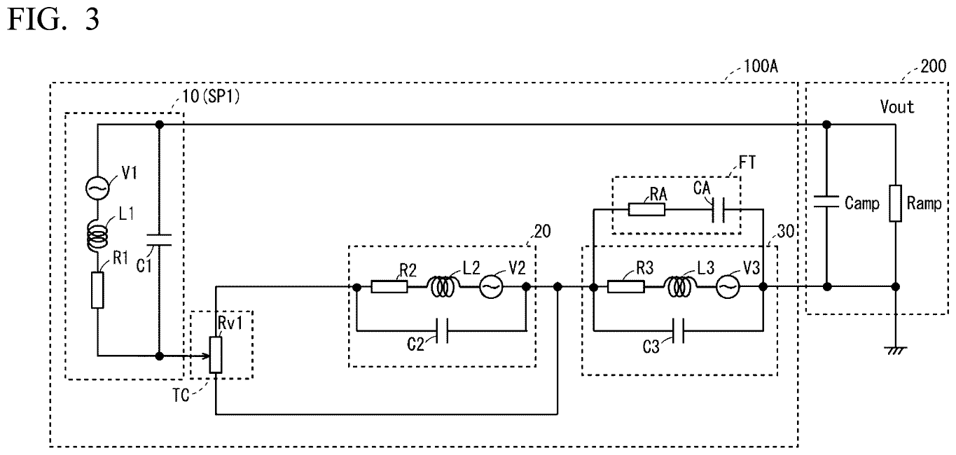

FIG. 3 is a diagram showing an equivalent circuit of a pickup device 100A according to a second embodiment. The differences between the pickup device 100 according to the first embodiment and the pickup device 100A according to the second embodiment are as follows. A filter FT is connected to the third coil 30, which may be involved in the occurrence of resonance and anti-resonance. The filter FT is a low-pass filter including a resistor RA and a capacitor CA. In this case, the filter FT functions as a filter that improves the high-frequency characteristics, and can suppress deterioration of the sound quality by stabilizing the disturbance in the amplitude of the string vibration in the high wavelength band.

### (3) Third Embodiment

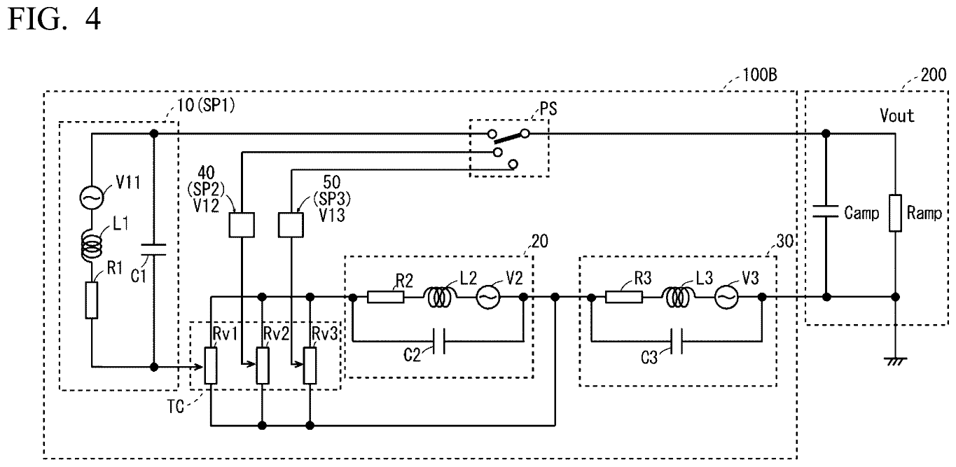

In the embodiments described above, an example in which the pickup device 100 includes one single coil pickup SP1 (first coil 10) has been described. However, the pickup device 100 may include a plurality of single coil pickups. FIG. 4 is an equivalent circuit showing a pickup device 100B according to another embodiment. The differences between the pickup device 100B and the pickup device 100 are follows. The pickup device 100B includes additional single coil pickups SP2 and SP3, which are different from the single pickup SP1, and a pickup selector PS. The single coil pickups SP2 and SP3 are a fourth coil 40 and a fifth coil 50.

The tuning circuit TC further includes variable resistors Rv2 and Rv3 corresponding to the fourth coil 40 and the fifth coil 50. The variable resistors Rv2 and Rv3 are, for example, rotary volumes. The fourth coil 40 is connected to the variable resistor Rv2. The fifth coil 50 is connected to the variable resistor Rv3. The equivalent circuits of the fourth coil 40 and the fifth coil 50 are the same as the equivalent circuit of the first coil 10. Therefore, the illustration is omitted. The first coil 10, the fourth coil 40, and the fifth coil 50 are connected to the pickup selector PS. The pickup selector PS switches and selects the single coil pickup that is connected to the amplifier 200.

In the pickup device 100B, the induced electromotive force of the first coil 10 is denoted v11, the induced electromotive force of the fourth coil 40 is denoted v12, and the induced electromotive force of the fifth coil 50 is denoted v13. Furthermore, in the pickup device 100B, the induced electromotive force of the second coil 20 is denoted v2, and the induced electromotive force of the third coil 30 is denoted v3. In the pickup device 100B, the induced electromotive force v2 is smaller than the smallest value among the induced electromotive forces v11 to v13. Further, the sum of the induced electromotive force v2 and the induced electromotive force v3 is larger than the largest value among the induced electromotive forces v11 to v13. In a case where the pickup device 100B according to the third embodiment is mounted on a guitar, the player is able to enjoy a plurality of tones because the single coil pickups SP1 to SP3 can be switched. The pickup device 100B according to the third embodiment includes three single coil pickups. However, the number of single coil pickups provided in the pickup device 100B is not limited to this. The pickup device 100B may include two or more single coil pickups.

### (4) Other Embodiments

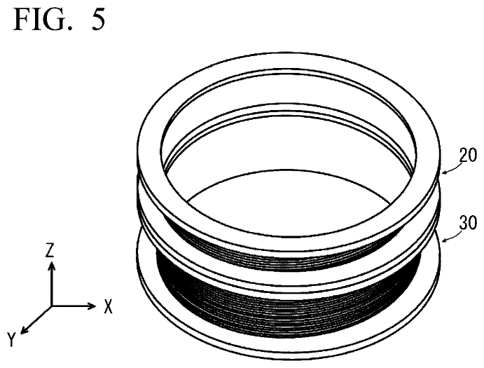

In the pickup device 100 according to the embodiments described above, an example in which the second coil 20 and the third coil 30 are separately provided has been described. However, the present disclosure is not limited to this. FIG. 5 is a perspective view showing the second coil 20 and a third coil 30 according to another embodiment. As shown in FIG. 5, the second coil 20 and the third coil 30 may have an integrally fixed (stacked) shape so as to be side-by-side in an up-down direction (Z direction). In this case, because the pickup device 100 becomes compact, mounting of the pickup device 100 on a guitar becomes easier.

### (5) Correspondence Between Components in Claims and Units in Embodiments

Hereinafter, an example of the correspondence between each of the components in the claims and each of the elements in the embodiments will be described. In the embodiments described above, the pole piece 13 is an example of a magnetic core, the first coil 10 is an example of a first coil, the second coil 20 is an example of a second coil, the third coil 30 is an example of a third coil, and the fourth coil 40 is an example of the fourth coil. The tuning circuit TC is an example of a tuning circuit, the variable resistor Rv1 is an example of a first variable resistor, the variable resistor Rv2 is an example of a second variable resistor, and the filter FT is an example of a filter.

### (6) Summary of Embodiments

(First item) A pickup device according to the present disclosure is a pickup device for detecting a vibration of a string of an electric string instrument, and includes:
a magnetic core that is configured to be adjacent to the string;
a first coil that is wound in a first direction around the magnetic core;
a second coil that is connected in series to the first coil, and is wound in a second direction which is different from the first direction;
a third coil that is connected in series to the second coil, and is wound in the second direction; and
a tuning circuit,
the tuning circuit includes a first variable resistor, which is connected to the first coil and the second coil and is configured to adjust a magnitude of an induced electromotive force of the second coil,
the first coil is configured to detect the vibration of the string, and an external magnetic field noise which is different from the vibration of the string, and
the second coil and the third coil are configured to detect the external magnetic field noise.

According to the pickup device of the first item, because the second coil and the third coil are wound in the opposite direction to the first coil, it is possible to cancel out an external magnetic field noise detected by the first coil. Therefore, a hum noise can be reduced.

Furthermore, in the pickup device according to the first item, the first variable resistor and the second coil form a low-pass filter. In a case where the inductance value of the second coil is large, the cutoff frequency becomes low. As a result, a reduction in the amplitude and a rotation in the phase occur, and the tone of the output sound may contain an external magnetic field noise. In order to remove the external magnetic field noise, it is necessary to reduce the inductance value of the second coil, which is connected to the first coil via the first variable resistor. In this case, it is plausible to reduce the cross-sectional area of the second coil. On the other hand, in a case where the cross-sectional area of the second coil is made smaller, a shortfall can sometimes occur in the induced electromotive force for canceling out the component of the induced electromotive force v1 generated in the first coil, caused by a change in the external magnetic field.

In the pickup device according to the first item, the second coil and the third coil are connected in series. Therefore, because it is possible to compensate for the shortfall in the induced electromotive force with the third coil, the inductance value of the second coil that constitutes the low-pass filter can be made even smaller. Furthermore, the cross-sectional area of the third coil only needs to be a cross-sectional area that can compensate for the shortfall in the induced electromotive force in the second coil. As a result, it is possible to achieve a reduction in size of the coils, and suppress a decrease in sound quality, while maintaining a reduction in hum noise.

(Second item) The pickup device according to the first item is configured such that
the first coil is configured to output a first signal that includes the external magnetic field noise,
the second coil and the third coil are configured to output a second signal that includes the external magnetic field noise, and
the external magnetic field noise detected by the first coil is removed from the first signal by adding the second signal to the first signal in a state where the first variable resistor has caused an amplitude of the second signal to be equal to or approximately equal to an amplitude of the first signal.

According to the pickup device of the second item, because the second coil and the third coil are wound in the opposite direction to the first coil, the phase of the first signal and the second signal is offset by 180 degrees. As a result of adding the second signal to the first signal in a state where the amplitude of the first signal and the amplitude of the second signal are equal or approximately equal, it becomes possible to output an appropriate signal of a string vibration in which the external magnetic field noise has been removed from the first signal.

(Third item) The pickup device according to the first or second item, further includes:
a fourth coil that is wound in the first direction around a magnetic core adjacent to the string,
the tuning circuit further includes a second variable resistor which is connected to the fourth coil and the second coil and which is configured to adjust the magnitude of the induced electromotive force of the second coil.

According to the pickup device of the third item, a plurality of coils that detect the vibration of the string are included. Therefore, when mounted on a string instrument, the player is able to enjoy a plurality of tones.

(Fourth item) The pickup device according to any one of the first to third items, further includes:
a filter that is connected to the third coil, and
the filter includes a capacitor and a resistor.

According to the pickup device of the fourth item, the first variable resistor is connected to the second coil, and the filter is connected to the third coil. Because the filter includes a capacitor and a resistor, the filter functions as a filter that improves the high-frequency characteristics. As a result, it is possible stabilize the disturbance in the amplitude of the output of a string vibration in the high wavelength band.

(Fifth item) The pickup device according to any one of the first to fourth items is configured such that
the second coil has an air core.

According to the pickup device of the fifth item, the permeability inside the coil can be reduced. Therefore, the inductance of the second coil can be easily reduced.

(Sixth item) The pickup device according to any one of the first to fifth items is configured such that
the third coil has an air core.

According to the pickup device of the sixth item, the permeability inside the coil can be reduced. Therefore, the inductance of the third coil can be easily reduced.

(Seventh item) The pickup device according to any one of the first to sixth items is configured such that
the second coil and the third coil have an integrally stacked shape in an up-down direction.

According to the pickup device of the seventh item, a compact configuration can be obtained.

(Eighth item) An electric string instrument includes the pickup device according to any one of the first to seventh items.

According to the electric string instrument of the eighth item, it is possible to provide an electric string instrument including a pickup device that is capable of achieving a reduction in the size of the coils, and suppression of the effect of the single pickups on the sound quality.

According to the present disclosure, it is possible to achieve a reduction in the size of a coil that mainly detects an external magnetic field noise, and to suppress a decrease in sound quality, while maintaining a reduction in a hum noise.

While preferred embodiments of the have been described and illustrated above, it should be understood that these are exemplary of the invention and are not to be considered as limiting. Additions, omissions, substitutions, and other modifications can be made without departing from the scope of the present disclosure. Accordingly, the invention is not to be considered as being limited by the foregoing description, and is only limited by the scope of the appended claims.

What is claimed is:

1. A pickup device for detecting a vibration of a string of an electric string instrument, comprising:
a first coil wound in a first direction around a magnetic core that is configured to be disposed adjacent to the string;
a second coil connected in series with the first coil, and wound in a second direction, which is different from the first direction; and
a third coil connected in series with the second coil, and wound in the second direction; and
a tuning circuit configured to adjust a magnitude of an induced electromotive force of the second coil,
wherein the first coil is configured to output a first signal representing the string vibration and any external magnetic field noise picked up by the first coil, and
wherein the second coil and the third coil are configured to output a second signal representing any external magnetic field noise picked up by the second and third coils.

2. The pickup device according to claim 1, wherein the tuning circuit comprises a first variable resistor connected to the first coil and the second coil.

3. The pickup device according to claim 2, wherein, in a state where the first signal and the second signal include the external magnetic field noise, and where the first variable resistor adjusts an amplitude of the second signal becomes substantially equal to an amplitude of the first signal, combining the first and second signals cancels the external magnetic field noised.

4. The pickup device according to claim 2, further comprising:
a fourth coil wound in the first direction around another magnetic core that is configured to be disposed adjacent to the string,
wherein the tuning circuit further includes a second variable resistor connected to the fourth coil and the second coil and configured to also adjust the magnitude of the induced electromotive force of the second coil.

5. The pickup device according to claim 4, wherein a sum of the induced electromotive force of the second coil and an induced electromotive force of the third coil is larger than a largest value among an induced electromotive force of the first coil and an induced electromotive force of the fourth coil.

6. The pickup device according to claim 2, further comprising:
a filter connected to the third coil,
wherein the filter includes a capacitor and a resistor.

7. The pickup device according to claim 1, wherein the second coil has an air core.

8. The pickup device according to claim 1, wherein the third coil has an air core.

9. The pickup device according to claim 1, wherein the second coil and the third coil are integrally formed and are stacked vertically.

10. An electric string instrument comprising:
a string;
a pickup device configured to detect a vibration of the string and comprising:
a first coil wound in a first direction around a magnetic core that is configured to be disposed adjacent to the string;
a second coil connected in series with the first coil, and wound in a second direction, which is different from the first direction;
a third coil connected in series with the second coil, and wound in the second direction; and
a tuning circuit configured to adjust a magnitude of an induced electromotive force of the second coil,
wherein the first coil is configured to output a first signal representing the string vibration and any external magnetic field noise picked up by the first coil, and
wherein the second coil and the third coil are configured to output a second signal representing any external magnetic field noise picked up by the second and third coils.

11. The electric string instrument according to claim 10, wherein the tuning circuit comprises a variable resistor connected to the first coil and the second coil.

12. The electric string instrument according to claim 11, wherein, in a state where the first signal and the second signal include the external magnetic field noise, and where the variable resistor adjusts an amplitude of the second signal becomes substantially equal to an amplitude of the first signal, combining the first and second signals cancels the external magnetic field noise.

13. The electric string instrument according to claim 11, further comprising:
a fourth coil wound in the first direction around another magnetic core that is configured to be disposed adjacent to the string,
wherein the tuning circuit further includes a second variable resistor connected to the fourth coil and the second coil and configured to also adjust the magnitude of the induced electromotive force of the second coil.

14. The electric string instrument according to claim 13, wherein a sum of the induced electromotive force of the second coil and an induced electromotive force of the third coil is larger than a largest value among an induced electromotive force of the first coil and an induced electromotive force of the fourth coil.

15. The electric string instrument according to claim 11, further comprising:
a filter connected to the third coil,
wherein the filter includes a capacitor and a resistor.

16. The electric string instrument according to claim 10, wherein the second coil has an air core.

17. The electric string instrument according to claim 10, wherein the third coil has an air core.

18. A pickup device for detecting a vibration of a string of an electric string instrument, the pickup device comprising:
a first coil wound in a first direction around a magnetic core that is configured to be adjacent to the string;
a second coil connected in series with the first coil, and wound around a first air core in a second direction, which is different from the first direction; and
a third coil connected in series with the second coil, and wound around a second air core in the second direction,
wherein the first coil is configured to output a first signal representing the string vibration and any external magnetic field noise picked up by the first coil, and
wherein the second and third coils are configured to output a second signal representing any external magnetic field noise picked up by the second and third coils.
